(19) United States
(12) Patent Application Publication
(10) Pub. No.: US 2015/0195985 A1
(43) Pub. Date: Jul. 16, 2015

(54) Easy Lift

(71) Applicant: Eli David Gershman, Richmond Hill (CA)

(72) Inventor: Eli David Gershman, Richmond Hill (CA)

(21) Appl. No.: 14/156,878

(22) Filed: Jan. 16, 2014

(51) Int. Cl. A01B 1/02; E01H 5/02

(52) U.S. Cl. CPC A01B 1/028; E01H 5/02

(57) ABSTRACT

This invention Easy Lift, is an apparatus, consists of a rod with a foot rest which attaches to a shovel's handle to provide leverage when lifting a loaded shovel.

The user places the foot on the foot rest to create an axils, so to prevent the rod from slipping backward, therefore, forcing the rod to pivot on itself and elevate the shovel's scoop, as the user pulls on the shovel's handle upwards.

### BACKGROUND OF INVENTION

This invention pertains to snow and garden shovels, making it easier and safer to use by adding a leverage and an axils to the shovel.

It is a known fact that the action of lifting a heavy loaded shovel strains the back and other muscles and can trigger a heart attack.

Easy Lift is attaches to a shovel's handle to provide leverage when lifting a loaded shovel.

Easy lift can be attached to an existing snow shovel as well as garden shovel and can also be produced and sold as a separate product.

### BRIEF SUMMARY

Using Easy Lift help the user lift the heavy load which is contained in the scoop of the shovel without bending down and straining the back, or other muscle as well as preventing vascular strain.

The user places the foot on the foot rest to create an axils, so to prevent the rod (axils) from slipping backward, therefore, forcing the rod to pivot on itself and elevate the shovel's scoop, as the user pulls on the shovel's handle upwards.

Easy lift can be attached to an existing snow shovel as well as garden shovel and can also be produced and sold as separate product.

### DESCRIPTION

An apparatus, Easy Lift is a rod with a foot rest which attaches to a shovel's handle (see drawing FIGS. 2 and 3) to provide leverage when lifting a loaded shovel.

Using Easy Lift help the user lift the heavy the load which is contained in the scoop of the shovel without bending down and straining the back or any other muscle.

The user places the foot on the foot rest to create an axils, so to prevent the rod from slipping backward, therefore, forcing the rod to pivot on itself and elevate the shovel's scoop, as the user pulls on the shovel's handle upwards.

Easy lift can be attached and used with a snow shovel as well as garden shovel.

Easy Lift can be made as a permanent, integrated part of the shovel, or as an ad-on which can be attached to an existing shovel.

The Rod/Leg can be collapsible/foldable for easy use and storage (see drawing FIGS. 4 and 4A).

Easy lift can be made out of plastic, metal, wood or any other suitable materials.

The height of the rod can vary according to the height of the person, or could be adjustable height (telescopic rod).

The attachment of the rod to the shovel's handle can be made with various types of clamps and attachments techniques and mechanism (see examples drawings FIGS. 1, 2,3 and 4).

The foot rest which is attached to the rod/leg can be made from various suitable materials such as: Plastic, Rubber, wood, metal and in any suitable shape and size.

The foot rest can be made as part of the rod/leg or as a separate part.

The rod could be hollow, hollow braced or solid material and can be made in any suitable shape or form.

### BRIEF DESCRIPTION OF DRAWINGS

Drawing Sheets are included.

FIG. 1 is a side view of an apparatus according to one exemplary but not limited embodiment of the present invention showing exemplary but not limited embodiment of the Foot Rest (4) exemplary but not limited embodiment of the Rod/Leg (1) which provide leverage when lifting a loaded shovel. Exemplary but not limited embodiment of the Collapsible Mechanism of the Rod/Leg (2) and an one exemplary but not limited embodiment of the attachment mechanism to the shovel (3).

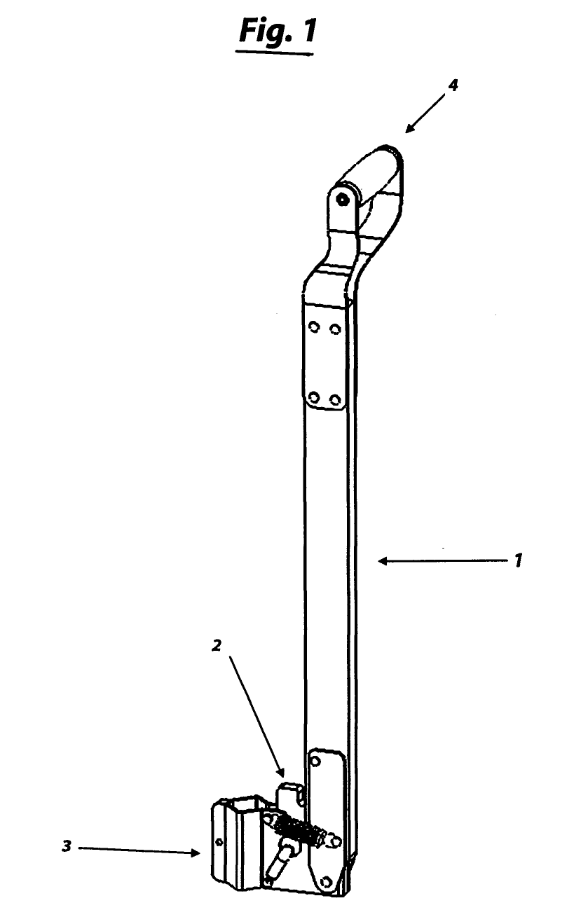

FIG. 2 is a three dimensional view showing another exemplary but not limited embodiment of the present invention attached to a shovel. Showing a different exemplary but not limited embodiment of the Foot Rest (4), exemplary but not limited embodiment of the Rod/Leg (1), a different exemplary but not limited embodiment of Collapsible Mechanism (2) a different exemplary but not limited embodiment of attachment method to the shovel (3) and the shovel handle (5).

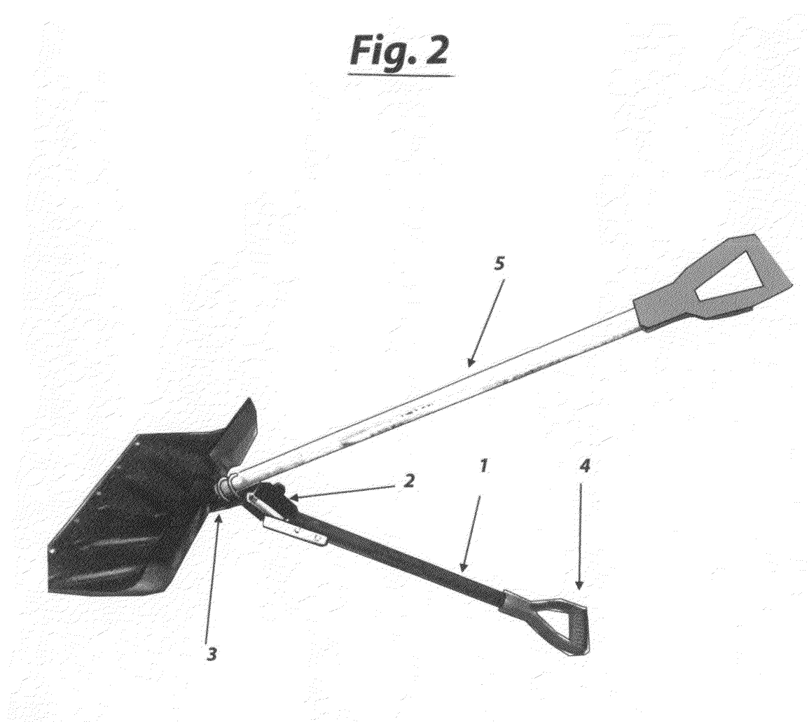

FIG. 3 is a side view of an apparatus attached to a shovel according to one exemplary but not limited embodiment of the present invention showing another exemplary but not limited embodiment method of attachment to a shovel (3), exemplary but not limited embodiment method of collapsible mechanism (2) and exemplary but not limited embodiment method of attachment of the Leg/Rod to both mechanism (1). The apparatus is showed attached to the shovel's handle (5) in a closed/collapsed position.

FIG. 4 is a side view of an apparatus not attached to a shovel, in an opened position, according to one exemplary but not limited embodiment of the present invention. Showing another exemplary but not limited embodiment method of attachment to a shovel (3), exemplary but not limited embodiment method of collapsible mechanism (2) and exemplary but not limited embodiment method of attachment of the Leg/Rod to both mechanism (1).

FIG. 4A is a side view of an apparatus not attached to a shovel in a closed/collapsed position, according to one exemplary but not limited embodiment of the present invention. Showing an exemplary but not limited embodiment method of attachment to a shovel (3), exemplary but not limited embodiment method of collapsible mechanism (2) and exemplary but not limited embodiment method of attachment of the Leg/Rod to both mechanism (1).

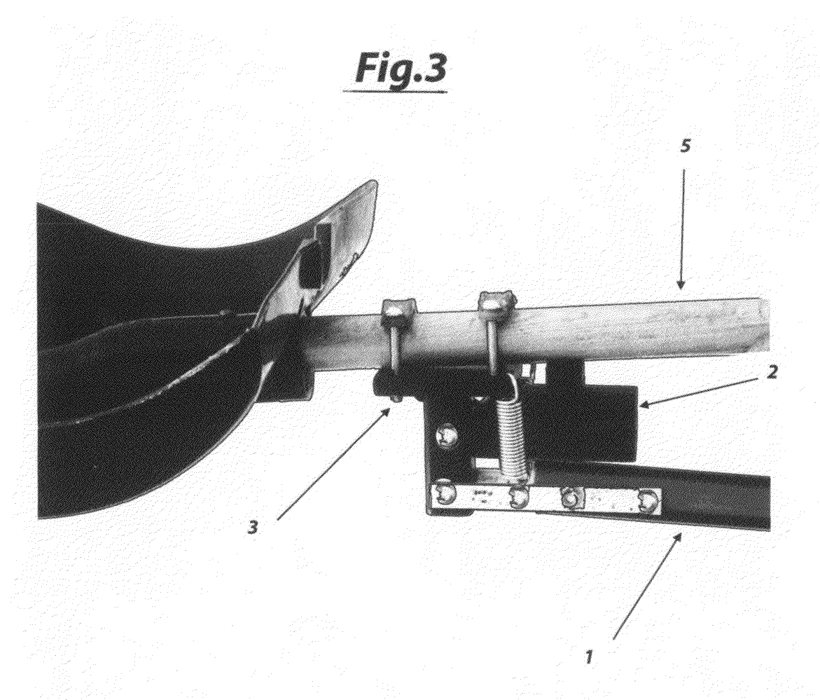

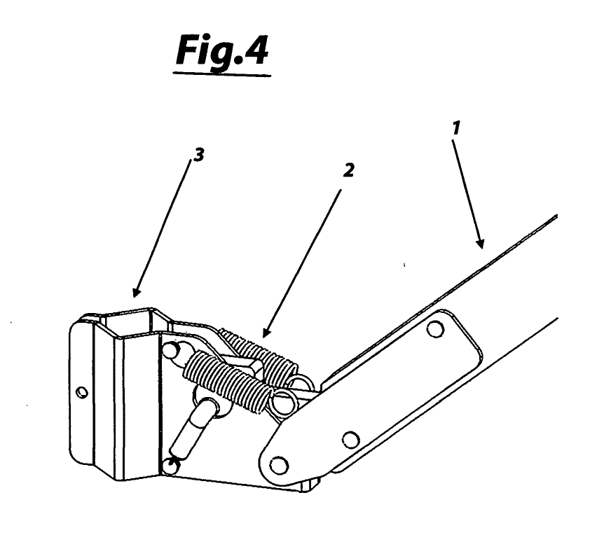

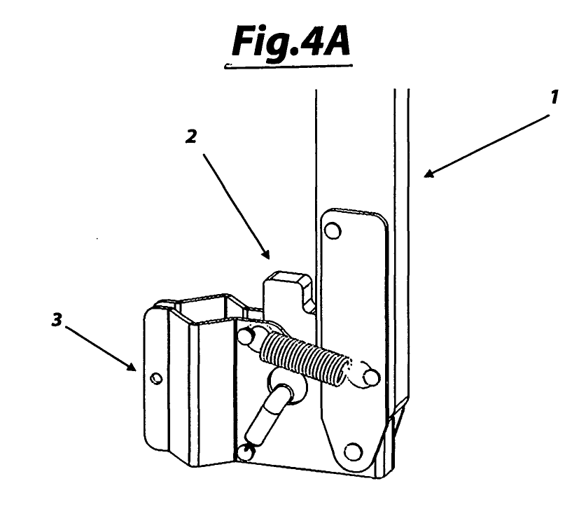

1. A device that helps elevate the scoop of a shovel, using leverage.
Apparatus Easy Lift is a rod/leg with a foot rest which attaches to a shovel's handle (shaft) to provide leverage when lifting a loaded shovel.
1A. The rod can be made as a permanent, integrated part of the shovel, or as an ad-on accessory which can be attached to the shovel.
1B. Easy Lift can be made out of various material such as: plastic, metal, wood or any other suitable materials.
1C. The height of the Rod/Leg can vary according to the height of the user, or could be made to be adjustable to accommodate different heights.
1D. The attachment of the Rod/Leg (see exemplary but not limited drawings FIGS. 3, 4,&2) to the shovel's handle can be made with various types of clamps (see exemplary but not limited drawings FIGS. 3, 4,&2) or any other suitable attachment methods and mechanisms.
1.E The foot rest which is attached to the rod can be made in various suitable shapes and sizes and can be made out of Plastic, Rubber, wood or metal or any other suitable material. The foot rest could be manufactured as one part with the Leg/Rod or as a separate part to be attached afterwards.

2. The apparatus (Rod/Leg) can be collapsible/foldable for easy use and storage or stationary in place.
